(19) United States
(12) Patent Application Publication
(10) Pub. No.: US 2022/0092292 A1
(43) Pub. Date: Mar. 24, 2022

(54) METHOD AND DEVICE FOR LIVING OBJECT DETECTION, AND STORAGE MEDIUM

(71) Applicant: SHENZHEN SENSETIME TECHNOLOGY CO., LTD., Shenzhen (CN)

(72) Inventors: Zhefeng GAO, Shenzhen (CN); Ruodai LI, Shenzhen (CN); Kun MA, Shenzhen (CN); Nanqing ZHUANG, Shenzhen (CN)

(21) Appl. No.: 17/544,246

(22) Filed: Dec. 7, 2021

Related U.S. Application Data
(63) Continuation of application No. PCT/CN2020/089865, filed on May 12, 2020.

(30) Foreign Application Priority Data
Nov. 27, 2019 (CN) 201911184524.X

(51) Int. Cl. G06K 9/00; G06K 9/32; G06T 7/593; G06T 7/80

(52) U.S. Cl. CPC G06K 9/00228; G06K 9/3233; G06T 2207/20224; G06T 7/85; G06T 7/593

(57) ABSTRACT

The disclosure provides a method and device for living object detection, and a storage medium. The method includes: acquiring, by each of two cameras of a binocular photographing device, a respective image containing an object to be detected, to obtain a first image and a second image; determining key point information in the first image and key point information in the second image; determining, according to the key point information in the first image and the key point information in the second image, depth information corresponding to each of a plurality of key points on the object to be detected; and determining, according to the depth information corresponding to each of the plurality of key points, a detection result indicating whether the object to be detected is a living object.

### CROSS-REFERENCE TO RELATED APPLICATIONS

This is a continuation of International Application No. PCT/CN2020/089865 filed on May 12, 2020, which claims priority to Chinese patent application No. 201911184524.X, filed to the National Intellectual Property Administration, PRC on Nov. 27, 2019, and entitled “Method and device for living object detection, and storage medium”. The contents of these applications are incorporated herein by reference in their entireties.

### BACKGROUND

At present, a monocular photographing device, a binocular photographing device and a depth photographing device may be used in living object detection. A device for living object detection with a single camera is simple and low in cost, and has a misjudgment rate at a magnitude of thousandth. The binocular photographing device can reach a misjudgment rate of ten-thousandth. The depth photographing device may reach a misjudgment rate up to millionth.

### SUMMARY

The disclosure relates to the field of computer vision, and more particularly to a method and device for living object detection, an electronic device and a storage medium.

According to the disclosure, provided is a method for living object detection, including: acquiring, by each of two cameras of a binocular photographing device, a respective image containing an object to be detected, to obtain a first image and a second image; determining key point information in the first image and key point information in the second image; determining, according to the key point information in the first image and the key point information in the second image, depth information corresponding to each of a plurality of key points on the object to be detected; and determining, according to the depth information corresponding to each of the plurality of key points, a detection result indicating whether the object to be detected is a living object.

According to the disclosure, provided is a device for living object detection, including: an image acquisition module, configured to acquire, by each of two cameras of a binocular photographing device, a respective image containing an object to be detected, to obtain a first image and a second image; a first determination module, configured to determine key point information in the first image and key point information in the second image; a second determination module, configured to determine, according to the key point information in the first image and the key point information in the second image, depth information corresponding to each of a plurality of key points on the object to be detected; and a third determination module, configured to determine, according to the depth information corresponding to each of the plurality of key points, a detection result indicating whether the object to be detected is a living object.

According the disclosure, provided is a non-transitory computer-readable storage medium having a computer program stored thereon, wherein the computer program, when being executed by a processor, implements a method for living object detection, the method including: acquiring, by each of two cameras of a binocular photographing device, a respective image containing an object to be detected, to obtain a first image and a second image; determining key point information in the first image and key point information in the second image; determining, according to the key point information in the first image and the key point information in the second image, depth information corresponding to each of a plurality of key points on the object to be detected; and determining, according to the depth information corresponding to each of the plurality of key points, a detection result indicating whether the object to be detected is a living object.

According the disclosure, provided is a device for living object detection, including: a processor and a memory configured to store instructions executable for the processor. The processor is configured to call the executable instructions stored in the memory to acquire, by each of two cameras of a binocular photographing device, a respective image containing an object to be detected, to obtain a first image and a second image; determine key point information in the first image and key point information in the second image; determine, according to the key point information in the first image and the key point information in the second image, depth information corresponding to each of a plurality of key points on the object to be detected; and determine, according to the depth information corresponding to each of the plurality of key points, a detection result indicating whether the object to be detected is a living object.

The embodiments of the disclosure also provide a computer program that, when being executed by the processor, implements any above method for living object detection.

It is to be understood that the above general descriptions and detailed description below are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a flowchart of a method for living object detection according to an exemplary embodiment of the disclosure.

FIG. 2 illustrates a flowchart of another method for living object detection according to an exemplary embodiment of the disclosure.

FIG. 3 illustrates a flowchart of another method for living object detection according to an exemplary embodiment of the disclosure.

FIG. 4 illustrates a flowchart of another method for living object detection according to an exemplary embodiment of the disclosure.

FIG. 5 illustrates a schematic diagram of a scenario where depth information corresponding to a key point is determined according to an exemplary embodiment of the disclosure.

FIG. 6 illustrates a flowchart of another method for living object detection according to an exemplary embodiment of the disclosure.

FIG. 7 illustrates a flowchart of another method for living object detection according to an exemplary embodiment of the disclosure.

FIG. 8 illustrates a block diagram of a device for living object detection according to an exemplary embodiment of the disclosure.

FIG. 9 illustrates a structural schematic diagram of a device for living object detection according to an exemplary embodiment of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations described in the following description of exemplary embodiments do not represent all implementations consistent with the disclosure. Instead, they are merely examples of devices and methods consistent with some aspects related to the disclosure as recited in the appended claims.

The terms used in the disclosure are for the purpose of describing particular embodiments only and are not intended to limit the disclosure. “A/an”, “said” and “the” in a singular form in the disclosure and the appended claims are also intended to include a plural form, unless other meanings are clearly indicated in the context. It is also to be understood that the term “and/or” as used herein refers to and includes any or all possible combinations of one or more of the associated listed items.

It is to be understood that, although terms “first”, “second”, “third” and the like may be used to describe various information in the disclosure, the information should not be limited by these terms. These terms are only used to distinguish the information of the same type. For example, without departing from the scope of the disclosure, “first information” may also be referred to as “second information” and, similarly, “second information” may also be referred to as “first information”. For example, term “if” as used here may be explained as “while” or “when” or “in response to determining that”, which depends on the context.

The method for living object detection provided in the embodiments of the disclosure may be applied to a binocular photographing device, which may reduce the misjudgment rate of living object detection of the binocular photographing device without increasing the hardware cost. The binocular photographing device includes two cameras, one of which may be a Red Green Blue (RGB) camera and the other may be an Infra-red (IR) camera. Of course, the two cameras included in the binocular photographing device may both be RGB cameras or may both be IR cameras, which is not limited in the disclosure.

It is to be noted that the technical solution in which an RGB camera and an IR camera (or two RGB cameras or two IR cameras) are purely used instead of the binocular photographing device in the disclosure, and the method for living object detection provided in the disclosure is used to achieve the purpose of reducing the misjudgment rate of living object detection shall also fall within the protection scope of the disclosure.

The technical solutions provided in the embodiments of the disclosure may have the following beneficial effects.

In the above embodiment, each of two cameras of a binocular photographing device may acquire an image containing an object to be detected, to obtain a first image and a second image; depth information corresponding to each of multiple key points on the object to be detected is determined according to key point information in the two images, and then whether the object to be detected is a living object is further determined. In this way, the precision of living object detection by the binocular photographing device may be improved and the misjudgment rate may be reduced, without increasing the cost. It is to be noted that the classifier may include, but is not limited to, a Support Vector Machine (SVM) classifier, or may include other types of classifiers, which is not specifically limited here.

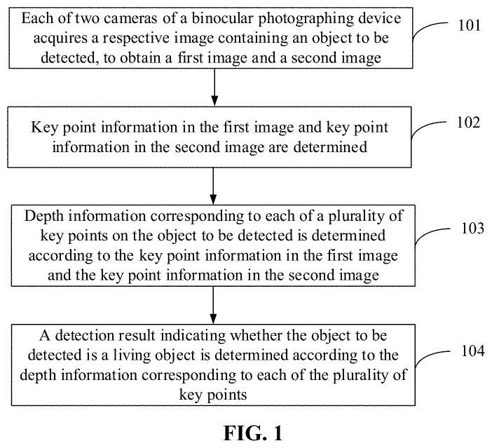

As illustrated in FIG. 1, a method for living object detection according to an exemplary embodiment includes the following actions.

At operation 101, each of two cameras of a binocular photographing device acquires a respective image containing an object to be detected, to obtain a first image and a second image.

In the embodiments of the disclosure, an image containing an object to be detected may be acquired by each of two cameras of the binocular photographing device, so as to obtain the first image acquired by one of the two cameras and the second image acquired by the other of the two cameras. The object to be detected may be an object that requires living object detection, for example, a human face. The human face may be a real human face, or a human face image printed or displayed on an electronic screen. The disclosure is intended to determine a real human face.

At operation 102, key point information in the first image and key point information in the second image are determined.

If the object to be detected includes a human face, then the key point information is key point information of the human face, including but not limited to information of face shape, eyes, nose, mouth and other parts.

At operation 103, depth information corresponding to each of a plurality of key points on the object to be detected is determined according to the key point information in the first image and the key point information in the second image.

In the embodiments of the disclosure, depth information refers to a distance from a key point on the object to be detected to a baseline in a world coordinate system. The baseline is a straight line formed by connecting optical centers of the two cameras of the binocular photographing device.

In a possible implementation, the depth information corresponding to each of plurality of face key points on the object to be detected may be calculated by triangulation ranging according to face key point information in each of the two images.

At operation 104, a detection result indicating whether the object to be detected is a living object is determined according to the depth information corresponding to each of the plurality of key points.

In a possible implementation, the depth information corresponding to each of the plurality of key points may be input into a pre-trained classifier to, obtain a first output result that is output by the classifier and indicates whether the plurality of key points belong to the same plane. The detection result indicating whether the object to be detected is a living object is determined according to the first output result.

In another possible implementation, the depth information corresponding to each of the plurality of key points may be input into the pre-trained classifier, to obtain the first output result that is output by the classifier and indicates whether the plurality key points belong to the same plane. If the first output result indicates that the plurality key points belong to the same plane, the first image and the second image may be input into a pre-established living object detection model to obtain a second output result output by the living object detection model, in order to further ensure the accuracy of the detection result. Whether the object to be detected is a living object is determined according to the second output result. By determining the final detection result through the living object detection model after the filtration by the classifier, the precision of living object detection by the binocular photographing device is further improved.

In the above embodiments, each of two cameras of a binocular photographing device may acquire an image containing an object to be detected, to obtain a first image and a second image; depth information corresponding to each of multiple key points on the object to be detected is determined according to key point information in the two images, and then whether the object to be detected is a living object is further determined. In this way, the precision of living object detection by the binocular photographing device may be improved and the misjudgment rate may be reduced, without increasing the cost. It is to be noted that the classifier may include, but is not limited to, a Support Vector Machine (SVM) classifier, or may include other types of classifiers, which is not specifically limited here.

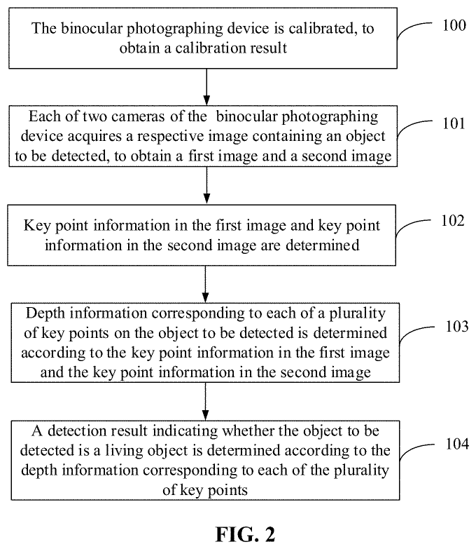

In some embodiments, as illustrated in FIG. 2, before operation 101, the method may further include operation 100.

At operation 100, the binocular photographing device is calibrated, to obtain a calibration result.

In the embodiments of the disclosure, the calibration of the binocular photographing device refers to calibrating an internal parameter of each of the two cameras and an external parameter between the two cameras.

The internal parameter of the camera refers to a parameter that can reflect the property of the camera itself, which may include but not limited to at least one of the following: an optical center, a focal length and a distortion parameter. Namely, the internal parameter may be one or a combination of at least two of these parameters given as examples.

The optical center of the camera is the origin of a camera coordinate system where the camera is located, and is the center of a convex lens for imaging in the camera. The focal length refers to the distance from the focus of the camera to the optical center. The distortion parameter includes a radial distortion parameter and a tangential distortion parameter. A radial distortion and a tangential distortion are position deviations of an image pixel produced along a lengthwise or tangential direction respectively with a distortion center as the center point, which lead to the deformation of the image.

The external parameter between the two cameras refers to a transformation parameter of the position and/or gesture of one camera relative to the other camera. The external parameter between the two cameras may include a rotation matrix R and a translation matrix T. The rotation matrix R is a rotation angle parameter produced relative to the coordinate axes x, y and z respectively when a camera is transformed to the camera coordinate system of the other camera. The translation matrix T is a translation parameter of the origin produced when a camera is transformed to the camera coordinate system of the other camera.

In a possible implementation, the binocular photographing device may be calibrated by any of: linear calibration, nonlinear calibration and two-step calibration. The linear calibration is a calibration manner in which a nonlinear problem of the camera distortion is not taken into account, and can be used when camera distortion is not considered. The nonlinear calibration refers a calibration manner in which due to that a lens distortion is obvious, and a distortion model must be introduced to transform a linear calibration model into a nonlinear calibration model, so as to solve camera parameters by a nonlinear optimization method. In the two-step calibration, with Zhang's calibration manner as an example, an internal parameter matrix of each camera is determined at first, and the external parameter between the two cameras is then determined according to the internal parameter matrixes.

In the above embodiment, the binocular photographing device may be calibrated firstly to obtain the internal parameter of each of the two cameras of the binocular photographing device and the external parameter between the two cameras of the binocular photographing device, so as to accurately determine the depth information corresponding to each of the multiple key points subsequently. High availability is achieved.

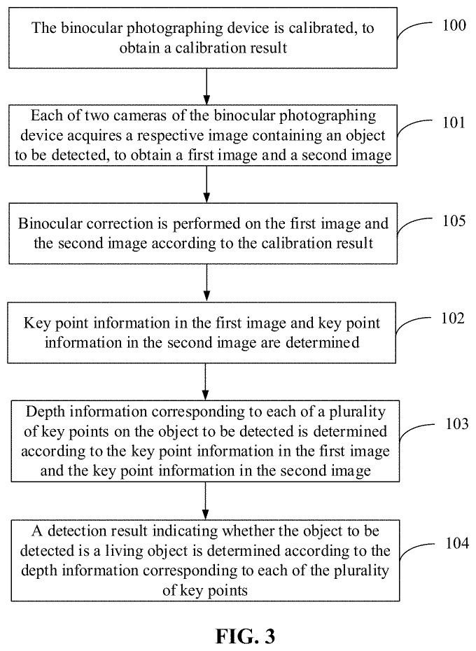

In some embodiments, as illustrated in FIG. 3, after operation 101, the method may further include operation 105.

At operation 105, binocular correction is performed on the first image and the second image according to the calibration result.

In the embodiments of the disclosure, binocular correction refers to that distortion elimination and line alignment are respectively performed on the first image and the second image according to the internal parameter of each of the two cameras and the external parameter between the two cameras obtained after the calibration. Thus, imaging origins of the first image and the second image are consistent with each other, optical axes of the two cameras are parallel to each other, imaging planes of the two cameras are in the same plane, and an epipolar line is aligned.

Distortion elimination may be performed on the first image and the second image respectively according to the distortion parameter of each of the two cameras of the binocular photographing device. Moreover, line alignment may also be performed on the first image and the second image according to the internal parameter of each of the two cameras of the binocular photographing device and the external parameter between the two cameras of the binocular photographing device. In this way, in subsequently determining the parallax of the same key point on the object to be detected between the first image and the second image, a two-dimensional matching process may be reduced to a one-dimensional matching process, and the parallax of the same key point between the first image and the second image may be obtained by directly determining a position difference value of the same key point in the horizontal direction between the two images.

In the above embodiment, by performing binocular correction on the first image and the second image, the two-dimensional matching process may be reduced to the one-dimensional matching process in subsequently determining the parallax of the same key point on the object to be detected between the first image and the second image, thereby reducing the time consumed in the matching process and narrowing the range in which search is to be conducted for match.

In some embodiments, operation 102 may include that: the first image and the second image are input into a pre-established key point detection model to obtain the key point information of the plurality of key points in the first image and the key point information of the plurality of key points in the second image respectively.

In the embodiments of the disclosure, the key point detection model may be a face key point detection model. A sample image labelled with key points may be used as an input to train a deep neural network, until an output result of the neural network matches the key points labelled in the sample image or falls within a tolerance, thus obtaining the face key point detection model. The deep neural network may be, but is not limited to, a Residual Network (ResNet), a googlenet, a Visual Geometry Group Network (VGG), and so on. The deep neural network may include at least one convolution layer, a Batch Normalization (BN) layer, a classification and output layer, and so on.

After the first image and the second image are acquired, the first image and the second image may be directly input into the above pre-established face key point detection model respectively, so as to obtain the key point information of the plurality of key points in each image.

In the above embodiment, the key point information of the plurality of key points in each image may be directly determined through the pre-established key point detection model. This is easy to realize, high availability is achieved.

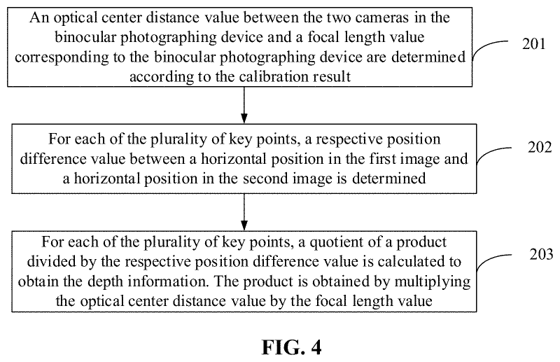

In some embodiments, as illustrated in FIG. 4, operation 103 may include the following operations 201, 202 and 203.

At operation 201, an optical center distance value between the two cameras in the binocular photographing device and a focal length value corresponding to the binocular photographing device are determined according to the calibration result.

In the embodiments of the disclosure, because the internal parameter of each camera of the binocular photographing device have been calibrated before, at this time, the optical center distance value between two optical centers c1 and c2 may be determined according to the positions of the optical centers of the cameras per se in the world coordinate system, as illustrated in FIG. 4.

Moreover, for the convenience of subsequent calculation, in the embodiments of the disclosure, the focal length values of the two cameras in the binocular photographing device are the same as each other. According to the calibration result obtained previously, the focal length value of any of the two cameras in the binocular photographing device may be determined as the focal length value of the binocular photographing device.

At operation 202, for each of the plurality of key points, a respective position difference value between a horizontal position in the first image and a horizontal position in the second image is determined.

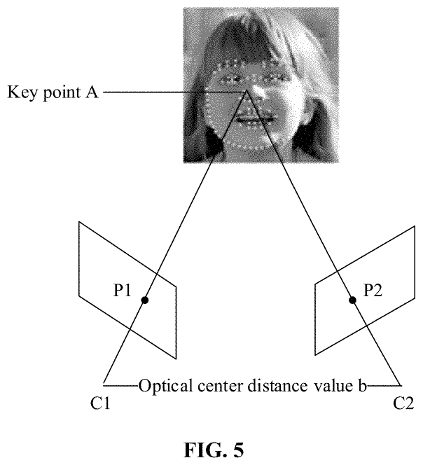

For example, as illustrated in FIG. 5, any key point A on the object to be detected corresponds to a pixel P₁ and a pixel P₂ in the first image and the second image respectively. In the embodiments of the disclosure, the parallax between P₁ and P₂ needs to be calculated.

Because the binocular correction has been performed on the two images before, the position difference value between P₁ and P₂ in the horizontal direction may be directly calculated, and the position difference value may be taken as the required parallax.

In the embodiments of the disclosure, by means of the method, the position difference value between the horizontal position in the first image and the horizontal position in the second image may be determined for each key point on the object to be detected, so as to obtain the parallax corresponding to each key point.

At operation 203, for each of the plurality of key points, a quotient of a product divided by the respective position difference value is calculated to obtain the depth information. The product is obtained by multiplying the optical center distance value by the focal length value.

In the embodiments of the disclosure, the depth information z corresponding to each key point may be determined by triangulation ranging, and may be calculated by formula (1) below:

$$Z = fb / d \qquad ( 1 )$$

where f is the focal length value corresponding to the binocular photographing device, b is the optical center distance value, and d is the parallax of the key point between the two images.

In the above embodiment, the depth information corresponding to each of the multiple key points in the object to be detected may be determined quickly, and high availability is achieved.

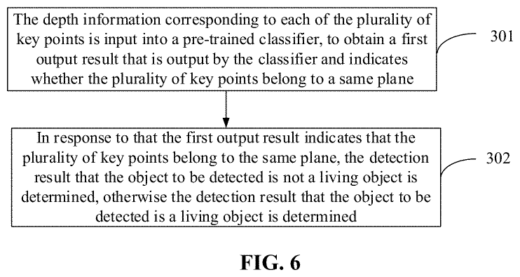

In some embodiments, as illustrated in FIG. 6, operation 104 may include the following operations 301 and 302.

At operation 301, the depth information corresponding to each of the plurality of key points is input into a pre-trained classifier, to obtain a first output result that is output by the classifier and indicates whether the plurality of key points belong to a same plane.

In the embodiments of the disclosure, the classifier may be trained by using multiple pieces of depth information in a sample library that have been labelled as belonging to the same plane or not belonging to the same plane, so that the output result of the classifier matches the result labelled in the sample library or falls within the tolerance range. In this way, after the depth information corresponding to each of the multiple key points in the object to be detected is acquired, the depth information may be directly input into the trained classifier to obtain the first output result output by the classifier.

In a possible implementation, the classifier may be an SVM classifier. The SVM classifier is a binary classification model. After the depth information corresponding to each of the multiple key points is input, the first output result obtained may indicate whether the multiple key points belong to the same plane or not.

At operation 302, in response to that the first output result indicates that the plurality of key points belong to the same plane, the detection result that the object to be detected is not a living object is determined, otherwise the detection result that the object to be detected is a living object is determined.

In the embodiments of the disclosure, in response to that the first output result indicates that the multiple key points belong to the same plane, a plane attack may have occurred. That is, illegal persons may try to acquire legal authorization by providing a dummy person through a photo, a printed portrait, an electronic screen and other ways. In this case, the detection result that the object to be detected is not a living object may be determined directly.

In response to that the first output result indicates that the multiple key points do not belong to the same plane, it may be determined that the object to be detected is a real person. In this case, the detection result that the object to be detected is a living object may be determined.

It has been verified by experiments that the misjudgment rate of living object detection has been reduced from 1/10,000 to 1/100,000 by the above method. The accuracy of living object detection by the binocular photographing device is greatly improved, and the performance bound of a living object detection algorithm, and user experience are also provided.

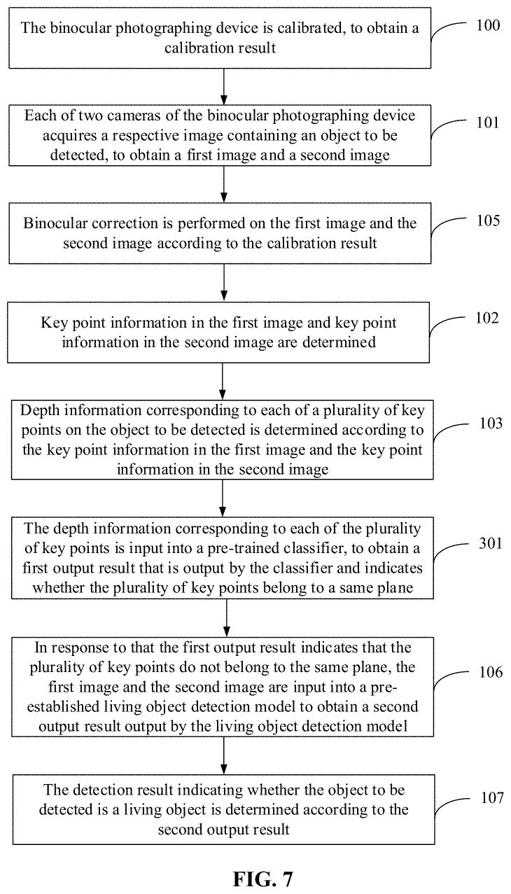

In some embodiments, as illustrated in FIG. 7, after operation 301, the method may further include the following operations 106 and 107.

At operation 106, in response to that the first output result indicates that the plurality of key points do not belong to the same plane, the first image and the second image are input into a pre-established living object detection model to obtain a second output result output by the living object detection model.

If the first output result indicates that the plurality of key points do not belong to the same plane, the first image and the second image may be input into a pre-established living object detection model, in order to improve the precision of living object detection. The living object detection model may be constructed by a deep neural network. The deep neural network may be, but not limited to, a ResNet, a googlenet, a VGG, and so on. The deep neural network may include at least one convolution layer, a BN layer, a classification and output layer, and so on. The deep neural network is trained by at least two sample images labelled with whether the object to be detected contained therein is a living object, so that the output result matches the result labelled in the sample image or falls within the tolerance range, thus obtaining the living object detection model.

In the embodiments of the disclosure, after the living object detection model is established in advance, the first image and the second image may be input into the living object detection model to obtain a second output result output by the living object detection model. The second output result here directly indicates whether the object to be detected corresponding to the two images is a living object.

At operation 107, the detection result indicating whether the object to be detected is a living object is determined according to the second output result.

In the embodiments of the disclosure, the final detection result may be directly determined according to the second output result above.

For example, the first output result output by the classifier is that the multiple key points do not belong to the same plane, but the second output result output by the living object detection model may be that the object to be detected is not a living object or may be that the object to be detected is a living object, so the accuracy of the final detection result is improved and misjudgment is further reduced.

Corresponding to the above method embodiments, device embodiments are also provided in the disclosure.

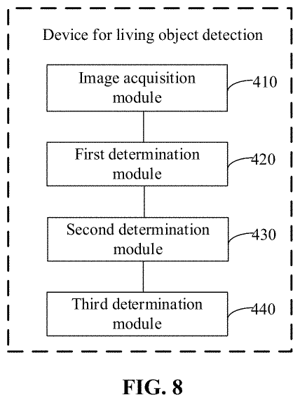

As illustrated in FIG. 8 of a block diagram of a device for living object detection according to an exemplary embodiment. The device may include an image acquisition module 410, a first determination module 420, a second determination module 430 and a third determination module 440. The image acquisition module 410 is configured to acquire, by each of two cameras of a binocular photographing device, a respective image containing an object to be detected, to obtain a first image and a second image. The first determination module 420 is configured to determine key point information in the first image and key point information in the second image. The second determination module 430 is configured to determine, according to the key point information in the first image and the key point information in the second image, depth information corresponding to each of a plurality of key points on the object to be detected. The third determination module 440 is configured to determine, according to the depth information corresponding to each of the plurality of key points, a detection result indicating whether the object to be detected is a living object.

In some embodiments, the device further includes: a calibration module configured to calibrate the binocular photographing device to obtain a calibration result. The calibration result includes an internal parameter of each of the two cameras of the binocular photographing device and an external parameter between the two cameras of the binocular photographing device.

In some embodiments, the device further includes: a correction module, configured to perform binocular correction on the first image and the second image according to the calibration result.

In some embodiments, the first determination module includes: a first determination submodule, configured to input the first image and the second image into a pre-established key point detection model to obtain the key point information of the plurality of key points in the first image and the key point information of the plurality of key points in the second image respectively.

In some embodiments, the second determination module includes: a second determination submodule, a third determination submodule and a fourth determination submodule. The second determination submodule is configured to determine, according to the calibration result, an optical center distance value between the two cameras in the binocular photographing device and a focal length value corresponding to the binocular photographing device. The third determination submodule is configured to: for each of the plurality of key points, determine a respective position difference value between a horizontal position in the first image and a horizontal position in the second image. The fourth determination submodule is configured to: for each of the plurality of key points, calculate a quotient of a product divided by the respective position difference value to obtain the depth information. The product is obtained by multiplying the optical center distance value by the focal length value.

In some embodiments, the third determination module includes: a fifth determination submodule and a sixth determination submodule. The fifth determination submodule is configured to input the depth information corresponding to each of the plurality of key points into a pre-trained classifier, to obtain a first output result that is output by the classifier and indicates whether the plurality of key points belong to a same plane. The sixth determination submodule is configured to: in response to that the first output result indicates that the plurality of key points belong to the same plane, determining the detection result that the object to be detected is not a living object, otherwise determining the detection result that the object to be detected is a living object.

In some embodiments, the device may further include: a fourth determination module and a fifth determination module. The fourth determination module is configured to: in response to that the first output result indicates that the plurality of key points do not belong to the same plane, inputting the first image and the second image into a pre-established living object detection model to obtain a second output result output by the living object detection model. The fifth determination module is configured to determine, according to the second output result, the detection result indicating whether the object to be detected is a living object.

In some embodiments, the object to be detected includes a face, and the key point information includes key point information of the face.

The device embodiments substantially correspond to the method embodiments, and thus related parts refer to part of descriptions of the method embodiments. The device embodiments described above are only illustrative, units described as separate parts therein may or may not be physically separated, and parts displayed as units may or may not be physical units. Namely they may be located in the same place or may also be distributed to multiple network units. Part or all of the modules therein may be selected according to a practical requirement to achieve the purpose of the solutions of the disclosure, and can be understood and implemented by those of ordinary skill in the art without creative work.

The embodiments of the disclosure also provide a computer-readable storage medium having a computer program stored thereon. When executed by a processor, the computer program implements any above method for living object detection.

In some embodiments, the embodiments of the disclosure provide a computer program product including a computer readable code. When the computer readable code, when running in a device, causes a processor in the device to execute instructions for implementing the method for living object detection provided in any above embodiment.

In some embodiments, the embodiments of the disclosure also provide another computer program product for storing computer readable instructions. The computer readable instructions, when executed, enable the computer to perform the operations of the method for living object detection provided in any above embodiment.

The computer program products may be specifically realized by means of hardware, software or a combination thereof. In an embodiment, the computer program product is specifically embodied as a computer storage medium, and in another embodiment, the computer program product is specifically embodied as software products, such as a Software Development Kit (SDK).

The embodiments of the disclosure also provide a device for living object detection, which may include: a processor and a memory for storing instructions executable for the processor. The processor is configured to call the executable instructions stored in the memory to implement any above method for living object detection.

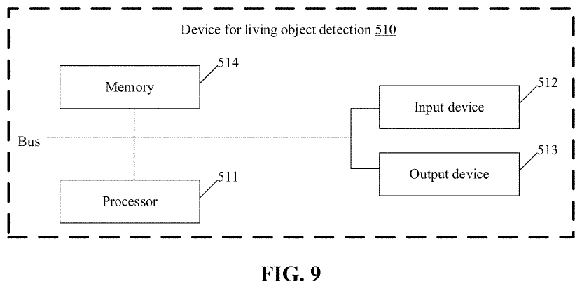

FIG. 9 illustrates a schematic diagram of a hardware structure of a device for living object detection provided by the embodiments of the disclosure. The device for living object detection 510 includes a processor 511, and may also include an input device 512, an output device 513 and a memory 514. The input device 512, the output device 513, the memory 514 and the processor 511 are connected with each other through a bus.

The memory includes, but is not limited to, a Random Access memory (RAM), a Read-Only Memory (ROM), an Erasable Programmable Read-only Memory (EPROM), or a Compact Disc Read-Only Memory (CD-ROM). The memory is used for related instructions and data.

The input device is configured to input data and/or signals, and the output device is used to output data and/or signals. The output device and the input device may be independent devices or an integrated device.

The processor may include one or more processors, such as one or more Central Processing Units (CPU). When the processor is a CPU, the CPU may be a single-core CPU or a multi-core CPU.

The memory is used to store program code and data of a network device.

The processor is used to call the program code and data in the memory to perform the actions in the above method embodiments. The details are described in the method embodiments and will not be repeated here.

It can be understood that FIG. 9 illustrates only a simplified design of a device for living object detection. In practical applications, the device for living object detection may also include other necessary components, which are, but not limited to, any number of input/output devices, processors, controllers, memories, etc., and all device for living object detections that can implement the embodiments of the disclosure shall fall within the protection scope of the disclosure.

In some embodiments, functions or modules contained in the device provided in the embodiments of the disclosure may be used to perform the method described in the above method embodiments, the specific implementation of which may refer to the description of the above method embodiments, and will not be described here for simplicity.

Other embodiments of the disclosure will be apparent to those skilled in the art from consideration of the specification and practice of the disclosure. This disclosure is intended to cover any variations, uses, or adaptations of the disclosure following the general principles thereof and including such departures from the disclosure as come within known or customary practice in the art. It is intended that the specification and examples be considered as exemplary only, with a true scope and spirit of the disclosure being indicated by the following claims.

The above are only preferred embodiments of the disclosure and are not intended to limit the disclosure. Any modifications, equivalent replacements, improvements and the like made within the spirit and principle of the disclosure shall fall within the scope of protection of the disclosure.

1. A method for living object detection, comprising:
acquiring, by each of two cameras of a binocular photographing device, a respective image containing an object to be detected, to obtain a first image and a second image;
determining key point information in the first image and key point information in the second image;
determining, according to the key point information in the first image and the key point information in the second image, depth information corresponding to each of a plurality of key points on the object to be detected; and
determining, according to the depth information corresponding to each of the plurality of key points, a detection result indicating whether the object to be detected is a living object.

2. The method of claim 1, wherein before acquiring, by each of the two cameras of the binocular photographing device, the respective image containing the object to be detected, to obtain the first image and the second image, the method further comprises:
calibrating the binocular photographing device to obtain a calibration result, wherein the calibration result comprises an internal parameter of each of the two cameras of the binocular photographing device and an external parameter between the two cameras of the binocular photographing device.

3. The method of claim 2, wherein after obtaining the first image and the second image, the method further comprises:
performing binocular correction on the first image and the second image according to the calibration result.

4. The method of claim 3, wherein determining the key point information in the first image and the key point information in the second image comprises:
inputting the first image and the second image into a pre-established key point detection model to obtain the key point information of the plurality of key points in the first image and the key point information of the plurality of key points in the second image respectively.

5. The method of claim 3, wherein determining, according to the key point information in the first image and the key point information in the second image, the depth information corresponding to each of the plurality of key points on the object to be detected comprises:
determining, according to the calibration result, an optical center distance value between the two cameras in the binocular photographing device and a focal length value corresponding to the binocular photographing device;
for each of the plurality of key points, determining a respective position difference value between a horizontal position in the first image and a horizontal position in the second image; and
for each of the plurality of key points, calculating a quotient of a product divided by the respective position difference value to obtain the depth information, wherein the product is obtained by multiplying the optical center distance value by the focal length value.

6. The method of claim 1, wherein determining, according to the depth information corresponding to each of the plurality of key points, the detection result indicating whether the object to be detected is a living object comprises:
inputting the depth information corresponding to each of the plurality of key points into a pre-trained classifier, to obtain a first output result that is output by the classifier and indicates whether the plurality of key points belong to a same plane; and
in response to that the first output result indicates that the plurality of key points belong to the same plane, determining the detection result that the object to be detected is not a living object, otherwise determining the detection result that the object to be detected is a living object.

7. The method of claim 6, wherein after obtaining the first output result that is output by the classifier and indicates whether the plurality of key points belong to the same plane, the method further comprises:
in response to that the first output result indicates that the plurality of key points do not belong to the same plane, inputting the first image and the second image into a pre-established living object detection model to obtain a second output result output by the living object detection model; and
determining, according to the second output result, the detection result indicating whether the object to be detected is a living object.

8. The method of claim 1, wherein the object to be detected comprises a face, and the key point information comprises key point information of the face.

9. A device for living object detection, comprising:
a processor; and
a memory configured to store instructions executable for the processor;
wherein the processor is configured to call the executable instructions stored in the memory to:
acquire, by each of two cameras of a binocular photographing device, a respective image containing an object to be detected, to obtain a first image and a second image;
determine key point information in the first image and key point information in the second image;
determine, according to the key point information in the first image and the key point information in the second image, depth information corresponding to each of a plurality of key points on the object to be detected; and
determine, according to the depth information corresponding to each of the plurality of key points, a detection result indicating whether the object to be detected is a living object.

10. The device of claim 9, the processor is further configured to call the executable instructions stored in the memory to:
calibrate the binocular photographing device to obtain a calibration result, wherein the calibration result comprises an internal parameter of each of the two cameras of the binocular photographing device and an external parameter between the two cameras of the binocular photographing device.

11. The device of claim 10, the processor is further configured to call the executable instructions stored in the memory to:
perform binocular correction on the first image and the second image according to the calibration result.

12. The device of claim 11, wherein in determining the key point information in the first image and the key point information in the second image, the processor is configured to call the executable instructions stored in the memory to:
input the first image and the second image into a pre-established key point detection model to obtain the key point information of the plurality of key points in the first image and the key point information of the plurality of key points in the second image respectively.

13. The device of claim 11, wherein in determining, according to the key point information in the first image and the key point information in the second image, the depth information corresponding to each of the plurality of key points on the object to be detected, the processor is configured to call the executable instructions stored in the memory to:
determine, according to the calibration result, an optical center distance value between the two cameras in the binocular photographing device and a focal length value corresponding to the binocular photographing device;
for each of the plurality of key points, determine a respective position difference value between a horizontal position in the first image and a horizontal position in the second image; and
for each of the plurality of key points, calculate a quotient of a product divided by the respective position difference value to obtain the depth information, wherein the product is obtained by multiplying the optical center distance value by the focal length value.

14. The device of claim 9, wherein in determining, according to the depth information corresponding to each of the plurality of key points, the detection result indicating whether the object to be detected is a living object, the processor is configured to call the executable instructions stored in the memory to:
input the depth information corresponding to each of the plurality of key points into a pre-trained classifier, to obtain a first output result that is output by the classifier and indicates whether the plurality of key points belong to a same plane; and
in response to that the first output result indicates that the plurality of key points belong to the same plane, determining the detection result that the object to be detected is not a living object, otherwise determining the detection result that the object to be detected is a living object.

15. The device of claim 14, the processor is further configured to call the executable instructions stored in the memory to:
in response to that the first output result indicates that the plurality of key points do not belong to the same plane, inputting the first image and the second image into a pre-established living object detection model to obtain a second output result output by the living object detection model; and
determine, according to the second output result, the detection result indicating whether the object to be detected is a living object.

16. The device of claim 9, wherein the object to be detected comprises a face, and the key point information comprises key point information of the face.

17. A non-transitory computer-readable storage medium having a computer program stored thereon, wherein the computer program, when being executed by a processor, implements a method for living object detection, the method comprising:
acquiring, by each of two cameras of a binocular photographing device, a respective image containing an object to be detected, to obtain a first image and a second image;
determining key point information in the first image and key point information in the second image;
determining, according to the key point information in the first image and the key point information in the second image, depth information corresponding to each of a plurality of key points on the object to be detected; and
determining, according to the depth information corresponding to each of the plurality of key points, a detection result indicating whether the object to be detected is a living object.

18. The non-transitory computer-readable storage medium of claim 17, wherein before acquiring, by each of the two cameras of the binocular photographing device, the respective image containing the object to be detected, to obtain the first image and the second image, the method further comprises:
calibrating the binocular photographing device to obtain a calibration result, wherein the calibration result comprises an internal parameter of each of the two cameras of the binocular photographing device and an external parameter between the two cameras of the binocular photographing device.

19. The non-transitory computer-readable storage medium of claim 18, wherein after obtaining the first image and the second image, the method further comprises:
performing binocular correction on the first image and the second image according to the calibration result.

20. The non-transitory computer-readable storage medium of claim 17, wherein determining, according to the depth information corresponding to each of the plurality of key points, the detection result indicating whether the object to be detected is a living object comprises:
inputting the depth information corresponding to each of the plurality of key points into a pre-trained classifier, to obtain a first output result that is output by the classifier and indicates whether the plurality of key points belong to a same plane; and
in response to that the first output result indicates that the plurality of key points belong to the same plane, determining the detection result that the object to be detected is not a living object, otherwise determining the detection result that the object to be detected is a living object.
